(19) United States
(12) Patent Application Publication
(10) Pub. No.: US 2024/0083226 A1
(43) Pub. Date: Mar. 14, 2024

(54) Pop-Up Roof for a Vehicle or Trailer

(71) Applicant: Yellow Sphere Innovations GmbH, Köln (DE)

(72) Inventor: Alexander Christ, Köln (DE)

(21) Appl. No.: 18/243,446

(22) Filed: Sep. 7, 2023

(30) Foreign Application Priority Data
Sep. 9, 2022 (EP) 22 194 949.8

(51) Int. Cl. B60J 7/16; B60P 3/34; E05F 15/50

(52) U.S. Cl. CPC B60J 7/1642; B60J 7/165; B60P 3/34; E05F 15/50; E05Y 2900/542

(57) ABSTRACT

The present invention relates to a pop-up roof (1) for a vehicle (100) or a trailer, in particular for a motor home or a camper van. Furthermore, the invention relates to a vehicle or a trailer, in particular a motor home or a camper van with such a pop-up roof. Furthermore, the invention relates to a method for using, in particular for assembling and/or disassembling, a pop-up roof (1) for a vehicle or a trailer, in particular for a motor home or a camper van.

The present invention relates to a pop-up roof for a vehicle or a trailer, in particular for a motor home or a camper van. Furthermore, the invention relates to a vehicle or a trailer, in particular a motor home or a camper van, having such a pop-up roof. Furthermore, the invention relates to a method for using, in particular for assembling and/or disassembling, a pop-up roof for a vehicle or a trailer, in particular for a motor home or a camper van.

In the prior art, pop-up roofs for vehicles or trailers are known which, for example, can be brought manually from a driving mode, for example for driving on the road, to a sleeping mode, for example for an overnight stay at a campsite, by assembling the pop-up roof, or vice versa by disassembling the pop-up roof from a sleeping mode to a driving mode.

However, these pop-up roofs have at least one of the following disadvantages. Some of the known pop-up roofs require manual operation. In addition, mechanical components can have more difficult and error-prone assembly and disassembly, increased maintenance requirements, increased wear, and complicated assembly and maintenance. The known pop-up roofs also have an undesirably large overall height, especially in the driving mode, which increases the aerodynamic drag of the vehicle and thus fuel consumption. Often, the known pop-up roofs are also harmful to the environment due to the required materials, especially metals, and/or the required lubricants. In addition, many of the known pop-up roofs provide insufficient comfort when used as sleeping accommodation. Furthermore, the protection against external environmental influences, such as wind, rain, solar radiation can be insufficient. In addition, the sleeping comfort in or under such a pop-up roof is insufficient, as the suspension of the sleeping surface is often inadequate.

It is the object of the present invention to at least partially eliminate the disadvantages described above. In particular, it is an object of the present invention to provide an optimized pop-up roof which preferably allows simple, reversible assembly and disassembly and is also low-maintenance and environmentally friendly. In addition, it may be an object to achieve the lowest possible overall height of a pop-up roof or of a vehicle with a pop-up roof. Furthermore, the pop-up roof should preferably provide the most comfortable sleeping accommodation possible.

The foregoing object is solved by a pop-up roof for a vehicle and a vehicle with such a pop-up roof, as well as a method for using a pop-up roof according to the independent claims. Further features and details of the invention result from the dependent claims, the description and the drawings. Features and details described in connection with the pop-up roof according to the invention naturally also apply in connection with the vehicle according to the invention, and/or the method according to the invention, and vice versa in each case, so that reference is or can always be made mutually with regard to the disclosure concerning the individual aspects of the invention.

Within the scope of the invention, reference can be made to a coordinate system, in particular comprising an x-, y-, and z-axis, which in particular can be configured as a right-hand system. In this context, the x-axis can be oriented substantially parallel to the direction of travel of the vehicle or trailer (front/rear), the y-axis can be oriented substantially perpendicular to the direction of travel (left/right), and the z-axis can be oriented substantially perpendicular to the x-axis and the y-axis (up/down), respectively. In addition, it may be provided in the context of the invention that the terms front, left, right and rear each refer to the direction of travel of a vehicle or a trailer, in particular a motor home or a camper van. In the context of the invention, a vehicle may also be understood to mean a trailer.

The invention relates to a pop-up roof for a vehicle or a trailer, in particular for a motor home or a camper van. Thereby, the pop-up roof comprises a floor, and at least three walls arrangeable on the floor, and a ceiling arrangeable on the at least three walls. The pop-up roof is reversibly movable by a drive element at least partially from a driving mode to a sleeping mode and vice versa from the driving mode to the sleeping mode. In the sleeping mode, the ceiling, the floor and the at least three walls form an interior sleeping space volume which extends an interior space of the vehicle or trailer, advantageously to provide space for a sleeping accommodation such as a bed for at least one person. In the driving mode, the ceiling and the floor are substantially contiguous to minimize the overall height of the pop-up roof.

In the sleeping mode, the pop-up roof can be configured in other words as a voluminous bulge, similar to a box, to provide an interior sleeping space volume, whereby the pop-up roof can be used, for example, in the form of a roof tent on a vehicle. Thereby, the interior volume of the vehicle or trailer, in which persons can move freely, can be increased by a sleeping accommodation in the interior sleeping space volume, for example for a bed. Thereby, the at least three walls may correspond to side walls arranged against each other, preferably with a front, a (in driving direction) left and a (in driving direction) right wall, wherein the pop-up roof preferably has a triangular shape in side view in sleeping mode, wherein the pop-up roof is higher at the front than at the rear. It is also conceivable that the pop-up roof has a rear wall instead of the front wall, the pop-up roof preferably having a triangular shape in side view, the pop-up roof being higher at the rear than at the front in sleeping mode, which can reduce air resistance when driving with a pop-up roof in sleeping mode. It is also conceivable that the pop-up roof has a front, left, right and rear wall, and these thus essentially form a cuboid together with the ceiling in sleeping mode. This can enable a particularly large interior sleeping space volume. The use of three walls may allow reduced material usage. Preferably, adjacent walls may be arrangeable substantially at right angles to each other in the sleeping mode, preferably to achieve a particularly high stability of the pop-up roof. In the sleeping mode, the pop-up roof is preferably accessible via the interior of the vehicle or trailer, in particular via an opening in the roof thereof, through which a person can enter the interior sleeping space volume delimited by the pop-up roof. The at least three walls are preferably at least partially foldable and attached substantially to the underside of the ceiling near the edge, as well as to the roof of the vehicle or trailer, to provide the most robust connection possible. In this regard, an attachment to the roof can preferably be made on the upwardly facing side of the roof, in particular substantially below the edge of the ceiling.

In the context of the invention, the roof of the vehicle or trailer substantially corresponds to its upper boundary. In particular, the roof may be substantially planar, as may be the case, for example, with motor homes and camper vans. Preferably, the pop-up roof can be arranged substantially above the roof, particularly in the sleeping mode. This means that the roof area can be practically utilized. In driving mode, the pop-up roof can also be arranged above the roof, which means that it can always be transported and is available at all times. It may also be provided that, in the driving mode, the pop-up roof or parts of the pop-up roof can be accommodated at least partially in the interior of the vehicle in order to further reduce the overall height of the pop-up roof and the height of the vehicle. This can relate in particular to the first, second and/or third hollow body, connection piece, medium supply device and/or at least one of the walls.

In the context of the invention, the floor of the pop-up roof can essentially be understood as the surface which is located directly above the roof of a vehicle or trailer, in particular even if the roof is at least partially interrupted at this point, for example due to an opening which serves as a passageway. The floor can limit the pop-up roof downward. Thus, in particular in the sleeping mode, an interior sleeping space volume can be created between the floor, the at least three walls and the ceiling. It may be provided that the floor, the at least three walls and the ceiling form a lockable space which acts like an insect screen, in particular in sleeping mode. It may also be provided that, below the ceiling, the walls are connected in a fabric-locking manner, thereby forming a substantially continuous insect screen. The at least three walls may have at least one reversibly closable ventilation slot to allow oxygen to be supplied from the outside.

The ceiling of the pop-up roof has a flat elongated shape and, in the simplest case, preferably corresponds to a substantially rectangular plate with four corners, which at least partially predetermines the shape of the pop-up roof. The top of the pop-up roof is preferably rigid. In other words, it is a movable cover for the pop-up roof. The ceiling comprises, for example, a resistant plastic in order to achieve the lowest possible weight. Alternatively or additionally, the ceiling may comprise a metal such as aluminum to achieve increased stability. The ceiling may be pivotable at at least one end via at least one hinge on the roof of the vehicle, thereby achieving particularly good guidance during assembly and disassembly of the pop-up roof. For example, the ceiling may be pivotable at the rear or front via at least one hinge on the roof of the vehicle, while the pop-up roof has exactly three walls on the other sides of the pop-up roof. It may also be provided that the ceiling comprises essentially of a fourth hollow body, which can preferably be reversibly filled with a medium via a fourth connection piece, in particular as described below for the other hollow bodies. Preferably, the ceiling has a sealing element on the underside at the outermost edge, which advantageously extends over the entire circumference. For example, this may be a hose-shaped rubber seal.

In the driving mode, the ceiling of the pop-up roof preferably lies substantially flat on the roof of the vehicle. In other words, the ceiling and the floor are essentially adjacent to each other or are at a minimum distance from each other. However, this can also mean that components of the pop-up roof are positioned between the ceiling and the roof, and thus the ceiling and the roof are at a minimized distance from one another, for example the first, second and/or third hollow body, which will be described in the further course, can still be located therebetween. Thus, an overall height of the pop-up roof is minimized in the driving mode, especially compared to the sleeping mode in which the pop-up roof is built. As a result, the overall height of the vehicle or trailer can also be minimized. Thus, the aerodynamic drag of the vehicle can be minimized while driving to save fuel and achieve optimized driving characteristics. Further, the vehicle can thus negotiate low underpasses while driving and/or use garages and the like with low headroom. In the driving mode, the ceiling can seal against the roof of the vehicle via the sealant to provide a medium-tight seal for the interior of the vehicle, in particular to seal off against external environmental influences such as rain, wind, sunlight and/or animals. Thereby, the at least three walls, the first, second and/or third hollow body can be completely accommodated within the pop-up roof, preferably completely shielded by the sealing element. Provision may be made to fix the pop-up roof in the driving mode via at least one fixing element, such as a manually operable clamp, to provide a reversibly releasable connection to the roof of the vehicle, whereby the pop-up roof is not unexpectedly unfolded during a journey and damaged or poses a safety risk. Preferably, the at least one fixation element is located on the ceiling, which can be assembled from the interior of the vehicle, thereby eliminating the need to enter the roof to fix the pop-up roof after it has been removed. In the driving mode, the interior sleeping volume of the pop-up roof may be substantially non-existent or zero.

An at least partial, preferably complete, reversible change from the driving mode to the sleeping mode is possible through a setup of the pop-up roof. A drive element according to the invention described in the further course is used here. Thereby, the interior sleeping space volume of the pop-up roof enclosed by the at least three walls and the ceiling can be substantially continuously enlarged by building up the pop-up roof. In doing so, the initially collapsed at least three walls are unfolded due to their attachment to the roof and ceiling. The distance between the floor and the ceiling can be continuously increased in the process. When the assembly is complete, the pop-up roof is in sleeping mode and the interior sleeping space volume is maximized, providing optimal sleeping comfort. In this case, the at least three walls may be substantially fully deployed, preventing water or solids such as branches and debris from accumulating on the walls or in folds of the walls. It is also conceivable to only partially assemble the pop-up roof due to lack of space, for example due to a tree located above it, i.e. to only partially convert it to sleeping mode, which results in less surface area to attack in strong winds to increase safety and preferably the interior sleeping space volume is still sufficient to provide space for a person to sleep.

According to another aspect of the present invention, it may be provided that the pop-up roof comprises a slatted frame positionable substantially parallel to the ground at a driving height substantially close to the ground in the driving mode and positionable substantially parallel spaced from the ground above the ground at a sleeping height in the sleeping mode. In this regard, the sleeping height may be adjustable between the driving height and a maximum slatted height by a first hollow body. The first hollow body may be substantially medium-tightly closed. The volume of the first hollow body can be reversibly reduced and increased by supplying a first medium, preferably air, via a first connection piece that can be arranged on the first hollow body to increase the volume (in other words, expansion) through a first medium supply device, in particular a pump, to increase the volume (in other words expansion), whereby the slatted frame can be raised upwards, and can be withdrawn from the first hollow body by the first medium supply device to reduce the volume (in other words folding), whereby the slatted frame can be lowered downwards. Thereby, the first hollow body can be arrangeable at least in sections between the edge of the slatted frame and the roof of the vehicle or trailer.

In the context of the present invention, a first hollow body may be understood to be a substantially elongated, ideally at least partially flexible, tube which is preferably inflatable by a first medium such as air and/or water.

The first hollow body can be arrangeable on the roof of the vehicle, in particular by a reversibly releasable fastening, for example by a keder connection. This allows easy installation and maintenance. Preferably, the first hollow body is located completely below the ceiling in the driving mode. It may be provided that the first hollow body substantially forms a rectangle or a U-shaped structure, in particular in plan view from above the roof of the vehicle or trailer. This results in a coherent first hollow body that can be filled, in particular via a single first connection piece.

In the simplest case, the slatted frame can be a board on which a mattress can preferably be positioned. The slatted frame can be essentially arrangeable on the first (and/or second) hollow body, in particular through a reversible releasable fastening, such as a clip connection or a Velcro fastener. As a result, the slatted frame can be assembled or disassembled at any time, in particular individual slats can be exchanged or moved. The slatted frame may have at least one slat, preferably a plurality of slats, which extends substantially perpendicular to the direction of travel. In addition, the slatted frame can have at least one, preferably two, bars extending in the direction of travel, which can preferably be arranged centrally and/or on the left and right of the slatted frame in the direction of travel and are attached to the at least one slat. In this case, the bars can be arranged essentially parallel to one another. Preferably, the at least one slat is thereby arranged substantially perpendicular to the beam, wherein in particular a plurality of slats can be arranged substantially parallel to each other, and thus perpendicular to the beams. In other words, this can result in an embodiment of a slatted frame known for normal beds, in which two beams are arranged parallel to one another on the left and right in the direction of travel, and at least one slat is arranged substantially perpendicularly thereto with further slats to form a support surface, e.g. for a mattress. The slatted frame or the at least one slat can thus improve sleeping comfort. It is also conceivable that the at least one slat, with both ends, can be inserted at least partially directly into the first (and/or second) hollow body, and is held in this way by increasing the volume of the first hollow body. This results in a particularly simple assembly.

In the context of the present invention, medium-tight can mean in particular watertight and/or airtight. In other words, it may be advantageous if substantially no medium can penetrate through the material of the first, second and/or third hollow body, in particular in the closed state (or connection spigot sealed), in particular no gas such as air and/or no liquid such as water and/or no solids such as dirt, dust and the like. In other words, a tightness is given, in particular if a corresponding connection piece is closed, whereby preferably in the case of an open connection piece, an exchange takes place only via the connection piece.

In the context of the present invention, a medium, in particular a first, second and/or third medium, can be a gas, preferably air, but alternatively or additionally also a liquid, in particular water. Gases may offer the advantage of low weight. Air can be advantageous because it is available essentially everywhere and/or can leave little contamination. Liquids may be advantageous to store and/or release heat. It is conceivable in the context of the present invention that the fluid in the first, second and/or third hollow bodies may be used for insulation and/or heating and/or cooling. For example, the first, second and/or third medium may be heated by the outside temperature and/or solar radiation during the day in summer and act as a heater in the evening or at night when the heat is continuously released. Alternatively or additionally, it may be envisaged to use the first, second and/or third medium as compressed air and/or consumable water, for example for showering, which may offer the advantage of water heated throughout the day, in other words an environmentally friendly camping shower, where, in particular due to the elevated storage on the roof, the water can be easily extracted via a hose. It may be envisaged to use the same medium in each of the first, second and third hollow bodies, preferably air or water.

In the context of the invention, a medium supply device, in particular a first, second and/or third medium supply device, can be understood as an element for supplying or withdrawing a medium, in particular a first, second and/or third medium, from a hollow body. In the simplest case, this can be a pump, such as an air pump or a water pump. A liquid/gas pump, which can convey a mixture of liquids such as water and gases such as air, is also conceivable. It may be a mechanically operated pump, which is cost effective and environmentally friendly. Furthermore, it can also be an automatic pump, which is preferably supplied via the on-board power supply of the vehicle or trailer and is advantageously integrated in the vehicle or trailer.

It can also be a pump supplied with pressure (e.g. water pressure or air pressure), which is able to fill a hollow body, in particular a first, second and/or third hollow body with overpressure, preferably above the atmospheric pressure, or to empty it even if it is under pressure. This results in the advantage of a particularly rigid configuration of the corresponding hollow body, similar to a particularly strongly inflated bicycle tire. It may be particularly preferred if only a single medium supply device is provided to supply or withdraw a medium, preferably air, from each of the first, second and/or third hollow bodies. This can offer the advantage of saving weight and/or costs, as well as simplifying handling, maintenance and assembly, with air in particular being available everywhere.

The first medium supply device can essentially adjust the volume and/or pressure within the first hollow body by at least partially supplying the first medium to the first hollow body (increasing pressure and/or volume) and by at least partially withdrawing the medium from the first hollow body. Thus, the lying height of the slatted frame can essentially be adjusted via the volume of the first hollow body. Furthermore, the pressure of the medium inside the first hollow body can be used to essentially determine how hard or resilient the slatted frame should be supported on the first hollow body. The first hollow body may be substantially evacuated in the driving mode. In other words, there is very little or ideally no first medium within the first hollow body. As a result, the slatted frame arranged on the first hollow body is located immediately above the floor at the driving height, in particular at the lowest adjustable height of the slatted frame. Thus, the overall height of the pop-up roof is minimized. Ideally, the slatted frame is essentially parallel above the floor or above the roof. On the one hand, this minimizes the overall height. On the other hand, the slatted grating can thus be positioned substantially automatically horizontally, in particular if the vehicle and the underlying ground are arranged substantially horizontally. The first hollow body can be at least partially or completely filled by the medium. Thus, the height of the slatted frame can be adjusted. When the first hollow body is completely filled by the medium, preferably in sleeping mode, and preferably even filled with overpressure, the slatted frame is at the maximum adjustable height. This can optimize the sleeping comfort of a person sleeping on the slatted frame, especially since a lying hardness similar to a conventional bed can thus be adjusted. It may also be provided to fill the first hollow body only partially with a medium. This can be advantageous in order to position the slatted frame at a sleeping height which is between the maximum slatted frame height and the driving height. In addition, this allows the slatted frame to be positioned softer due to the lower pressure of the first hollow body, in particular to achieve a sleeping sensation similar to a waterbed or air mattress. This can additionally lead to saving the volume of the medium and to a reduced energy demand as well as required filling time during filling.

It can be provided that the first hollow body has at least two chambers, which can be arranged in particular in sections along the edge of the slatted frame and the roof of the vehicle, preferably on the right and left in the direction of travel, advantageously in order to ensure compensation between a first heavier person and a second lighter person, who can be positioned parallel to the direction of travel in the pop-up roof on the slatted frame, in particular sleeping, wherein in particular the pressure of the medium in the chamber is higher on the side of the heavier person in order to enable a substantially horizontal alignment of the slatted frame. Alternatively or additionally, it can be provided that the first hollow body has at least two chambers, which in particular can be arranged in sections along the edge of the slatted frame and the roof of the vehicle, preferably further forward (towards the front of the vehicle) and rearward (towards the rear of the vehicle) in the direction of travel, in order to ensure compensation between a first heavier person and a second lighter person who can be positioned perpendicularly to the direction of travel in the pop-up roof on the slatted frame, in particular sleeping, wherein in particular the pressure of the medium in the chamber is higher on the side of the heavier person in order to enable a substantially horizontal alignment of the slatted frame. It can also be provided that in each case an inclined position of the vehicle can be compensated for, in particular by correspondingly providing one or the other chamber with higher/lower volume and/or pressure of the medium.

It may be provided that the first hollow body has a first connection piece, which is preferably closable. For example, in the simplest case it can be a preferably screwable or otherwise sealable valve, similar to a conventional air mattress, so that part of the medium cannot unexpectedly escape from the first hollow body during use (e.g. during the person sleeping in the pop-up roof). Preferably, the first connection piece, particularly when open, may be connectable to the first medium supply device to supply or withdraw a first medium from the first hollow body. The first connection piece can have a first non-return valve, which prevents part of the medium from escaping from the first hollow body when the first medium supply device is attached or removed.

According to a further aspect of the present invention, it may be provided that the drive element comprises a second hollow body, wherein the second hollow body is closed in a substantially medium-tight manner, and the volume of the second hollow body can be reversibly reduced and increased by introducing a second medium, preferably air, can be introduced into the second hollow body via a second connection piece, which can be arranged on the second hollow body, in order to increase the volume through a second medium supply device, and, as a result of its expansion, the pop-up roof can be brought at least partially into the sleeping mode (in other words, the pop-up roof is built up), and can be withdrawn from the second hollow body through the second medium supply device in order to reduce the volume, and, as a result of its folding, the pop-up roof can be brought at least partially into the driving mode (in other words, the pop-up roof is disassembled). In this case, the second hollow body can be arranged at least in sections between the edge region of the roof and the roof of the vehicle or trailer.

In the context of the present invention, a second hollow body may be understood as a substantially elongated, ideally at least partially flexible, tube which is preferably inflatable by a second medium such as air and/or water. In other words, a medium may be supplied to or withdrawn from the second hollow body, thereby increasing or decreasing the volume of the second hollow body. In the context of the invention, this can be used to set up and take down the pop-up roof, preferably due to the connection between the second hollow body, the roof and the ceiling, in particular in that when the second hollow body is substantially completely filled or at maximum volume, the pop-up roof can be placed and/or maintained in the sleeping mode without the latter switching back to the driving mode by itself at least partially. Thus, an optimized pop-up roof can be provided which, in particular, enables simple, reversible assembly and disassembly and is also low-maintenance and environmentally friendly. In simplified terms, the principle can be imagined as being similar to a bicycle tire or inner tube, whereby the latter is initially uninflated, then filled with air via a connecting piece, whereby initially its volume is greatly increased, and finally brought into its final shape (this corresponds essentially to the complete construction of the pop-up roof, which can represent the tire casing), whereby finally, preferably, a further supply of the medium merely increases the pressure in the bicycle inner tube and contributes to its dimensional stability.

The second hollow body is attached, at least in sections, to the edge region of the ceiling. The edge region of the ceiling can be understood as the part of the ceiling which is located on the substantially downwardly facing side of the ceiling. This may be the edge region of the ceiling, for example the outermost 40 cm, preferably, the outermost 30 cm, particularly preferably the outermost 20 cm, ideally the outermost 10 cm. Here, with a wider edge region, a more robust attachment of the second hollow body to the ceiling is possible, while the interior sleeping volume in the sleeping mode is thereby reduced. Conversely, a narrower edge area can maximize the interior sleeping volume.

The second hollow body is also attached at least in sections to the roof of the vehicle or trailer. In this regard, it may be advantageous if the second hollow body is attached substantially to an upwardly facing edge region of the roof of the vehicle or trailer, which is preferably located substantially immediately below the edge region of the ceiling in the driving mode, whereby when the pop-up roof is assembled and disassembled, it is assembled or disassembled as directly and as rectilinearly as possible away from the vehicle or trailer and towards the vehicle or trailer. In other words, a substantially overlapping edge region may be provided within which, in the driving mode, the downwardly facing edge region of the ceiling and the upwardly facing edge region of the roof are substantially directly superimposed. Preferably, the second hollow body can be arranged in this edge region.

It is particularly preferred if, essentially at least partially along the circumference of the ceiling of the pop-up roof, the second hollow body is arranged in sections alternately on the ceiling, in particular in the downward-facing edge region of the ceiling, and on the roof, in particular on the upward-facing edge region of the roof, the other component, for example the roof or the ceiling, preferably being free of the second hollow body in this region, in other words the second hollow body is not arranged there. In this way, it is still possible to assemble and disassemble the pop-up roof with a minimum of material or a volume of the second hollow body that is as small as possible. In this case, the respective successive sections on the ceiling and on the roof can be connected by upwardly projecting sections which are preferably attached neither to the roof nor to the ceiling, but are preferably connected only to adjacent sections of the second hollow body. The assembly of the pop-up roof can be carried out primarily by filling these upwardly projecting sections, in particular since they increase the distance between the roof and the ceiling to a particular extent when filled. Conversely, the pop-up roof can be disassembled primarily by emptying these upward sections. As a result, the pop-up roof can be completely assembled using a comparatively small volume of the second medium, especially in comparison with a pop-up roof in which the walls have to be completely or predominantly filled with the second medium for assembly.

In the context of the present invention, it is conceivable that the second hollow body is fastened to the roof and/or the ceiling at least in sections by a joint connection. In this case, the joint connection can have a non-detachable adhesive connection or riveted connection in order to advantageously produce a particularly robust and durable connection. Alternatively, it may be provided that the joining connection has a reversibly releasable screw connection or keder connection. This may be advantageous because the service life of a vehicle may be longer than that of the components of the pop-up roof, in particular the second hollow body, which may be less durable due to its requirements for reversible assembly and disassembly. Thus, simplified replacement and/or maintenance and assembly can preferably be achieved.

Preferably, the second hollow body can be fastened at least in sections to the right and left of the edge area of the roof in the direction of travel, advantageously through a keder connection to enable simple assembly and/or maintenance. It may be particularly preferred if the second hollow body is essentially identical on the right and left in order to ensure identical behavior during assembly and disassembly.

In this context, the second hollow body can preferably have at least one upwardly projecting section, in particular a substantially vertical upwardly projecting section, which extends substantially upwardly from the roof, in particular in the sleeping mode. In this context, vertical may describe a right angle. In other words, it may be provided that in particular the at least one upwardly projecting portion at least partially causes the assembly of the assembly roof during assembly due to the increase in its volume, in particular because it increases the distance between the ceiling and the roof to a particular extent compared, for example, with a portion of the second hollow body arranged only along the direction of travel. In other words, it may be envisaged that, in particular, the at least one upwardly protruding section during disassembly causes the disassembly of the pop-up roof due to the reduction of its volume, in particular because the distance between the ceiling and the roof is thereby reduced to a particular extent.

It may be particularly preferred if an upwardly projecting section of the second hollow body is located at the front left and front right in the direction of travel. In this way, a particularly symmetrical assembly and disassembly can be achieved, especially with regard to the left and right sides of the pop-up roof in the direction of travel. In other words, a pop-up roof that is essentially triangular in side view and in sleeping mode can thus be realized, with the pop-up roof being higher in the front area of the vehicle.

Alternatively, an upwardly projecting section of the second hollow body can also be located at the rear left and rear right in the direction of travel. In other words, a pop-up roof that is essentially triangular in side view and in sleeping mode can thus be realized, with the pop-up roof being higher in the rear area of the vehicle. This can be advantageous, as it also makes it conceivable to drive with the vehicle in sleeping mode, whereby a higher speed is made possible due to the comparatively lower air resistance in this configuration, without damaging the pop-up roof or negatively affecting the driving characteristics of the vehicle.

It is also conceivable that both at the front and at the rear the second hollow body has at least one upwardly projecting section on the left and right respectively. This results in a particularly symmetrical structure and disassembly, with the ceiling of the pop-up roof being arranged essentially parallel to the roof of the vehicle in this case. In other words, this can be a pop-up roof which is substantially cuboidal in the sleeping mode and which has a quadrangular, in particular substantially rectangular, configuration when viewed from the side of the vehicle. Furthermore, this may maximize the interior sleeping space volume that extends the interior space of the vehicle or trailer, in particular to provide space for a sleeping accommodation such as a bed for at least one person.

It is also conceivable that both the front and the rear have at least one upwardly projecting section on the left and right of the second hollow body. In this case, it may be intended that the two rear or front upward sections are longer, resulting in a forward or rearward inclination of the ceiling in sleeping mode. In other words, it can be a pop-up roof which is square in the side view of the vehicle in the sleeping mode, but not rectangular. An inclined position (in particular a non-parallel position) of the ceiling can basically prevent water from collecting on or in the ceiling, for example in the event of rain, and this ceiling from being damaged by the weight or even collapsing.

It is also conceivable that an upwardly projecting section is provided on the left side at the front and rear, in particular only there, or an upwardly projecting section is provided on the right side at the front and rear, in particular only there. Advantageously, this allows the pop-up roof to be opened to the respective side. In other words, the cross-section is triangular, with the pop-up roof being higher in sleeping mode on the side with the upwardly projecting section than on the other side. This has the advantage that the open side to the left or right is particularly large, which can increase comfort.

It may be particularly preferred that the second hollow body in the direction of travel at the front is fastened exclusively at least in sections to the edge region of the ceiling and not to the roof, while the second hollow body in the direction of travel on the left and right is fastened equally at least in sections to the edge region of the roof, preferably by a keder connection. Ideally, in this case, the second hollow body in the direction of travel at the front can be fastened essentially over the entire width of the roof in the downward-facing edge region of the roof, while on the left and right the second hollow body is fastened essentially over the entire length of the roof in the direction of travel (in particular with respect to the driving mode) to the upward-facing edge region of the roof. Preferably, the second hollow body has an upwardly projecting section between these aforementioned sections, in each case on the left front and right front, which connects the sections. This preferably results in a single coherent second hollow body. In other words, this is not formed at all in the rear area of the pop-up roof, on the right side along the roof, at the front right corner of the built-up pop-up roof by an upwardly projecting section, in the front area along the ceiling, at the front left corner of the built-up pop-up roof by an upwardly projecting section and on the left side along the roof. In other words, the pop-up roof may thereby be assembled in the front region while merely pivoted in the rear region. This can be advantageous in order, on the one hand, to make the volume of the second hollow body as small as possible and still allow the assembly and disassembly according to the invention. On the other hand, this may be particularly preferred in order to provide a combination of first and second hollow bodies in which the slatted frame is arranged on the first or second hollow body, in particular combined hollow body. In other words, the second hollow body may here replace the first hollow body completely or at least partially, or in particular form one and the same hollow body. In the case of a combined hollow body, this may be referred to as the first or second hollow body, in particular because it may be a single continuous hollow body which can preferably affect both assembly and disassembly of the pop-up roof and raising and lowering of the slatted frame. In this way, simultaneous assembly and disassembly of the pop-up roof and the slatted frame can be achieved, saving in particular material, weight, costs, and assembly and disassembly time. Alternatively, it can also be provided that, in accordance with the preceding embodiments, the second hollow body is not attached to the edge region of the ceiling at the front in the direction of travel, but instead is attached exclusively at the rear, at least in sections, and is not attached at all at the front, with an upwardly projecting section being formed at the rear left and rear right in each case. The result is otherwise a substantially identical structure, with the difference that the pop-up roof is substantially built up at the rear and pivoted at the front. This may be advantageous, as previously stated, to move the vehicle or trailer at least at some speed without removing the pop-up roof. It is also conceivable that, according to the preceding embodiments, the pop-up roof is assembled to the left or to the right while the latter, in particular, is merely pivoted to the right or to the left. This can be achieved by attaching the second hollow body only to the left or right of the downward-facing edge of the roof.

Preferably, the second hollow body can be attached at least in sections to the edge area of the ceiling at the front in the direction of travel, preferably through a keder connection to enable easy assembly and/or maintenance.

Preferably, the second hollow body can be attached at least in sections to the edge area of the roof at the rear in the direction of travel, preferably through a keder connection to enable simple assembly and/or maintenance. This can be advantageous in order to also achieve a raising of the pop-up roof in the rear area during assembly of the pop-up roof, which can in particular be lower than in the front area of the vehicle. In other words, the pop-up roof then forms a quadrilateral rather than a simple triangle in side view. This results in a slightly increased interior sleeping space volume.

Alternatively or additionally, the second hollow body can be arranged at least in sections on the edge region of the ceiling at the rear in the direction of travel. Thus, the second hollow body can essentially be made from a single coherent hollow body, which in particular runs once around the entire pop-up roof, and is preferably attached alternately to the ceiling and to the roof. This results in a particularly simple manufacturing option.

Within the scope of the invention, it is conceivable that the second hollow body comprises at least one chamber, wherein the at least one chamber is substantially medium-tight and the volume of the at least one chamber can be reversibly reduced and increased, wherein in the driving mode the volume of the chamber is substantially minimized and in the sleeping mode the volume of the chamber is larger than in the driving mode, preferably substantially maximized. By having a single contiguous second hollow body or chamber, the necessary volume of the second medium can be minimized and still achieve an assembly and disassembly of the set-up roof according to the invention, especially since only a single contiguous second hollow body is supplied with or withdrawn from a medium. A small volume of the second hollow body can minimize not only the material required for manufacture, but additionally the time and/or energy required for disassembly and assembly.

It can also be provided that the second hollow body has at least two chambers. This allows adjustability, whereby different chambers can each be pressurized with a different volume and/or pressure of the second medium, in particular in order to accelerate or slow down the assembly of the pop-up roof, to allow it to proceed in a controlled manner and/or to make the pop-up roof differently rigid at different points in the sleeping mode in order, for example, to compensate particularly efficiently for external environmental influences such as wind or rain.

It may be provided that the second hollow body has a second connection piece, which is preferably closable. For example, in the simplest case it can be a preferably screwable or otherwise sealable valve, similar to a conventional air mattress, so that part of the medium cannot unexpectedly escape from the second hollow body during use (e.g. during the person sleeping in the pop-up roof). Preferably, the second connection piece, when open, may be connectable to the second medium supply device to supply or withdraw a medium from the second hollow body. The second connection piece can have a second check valve, which prevents part of the medium from escaping from the second hollow body when the second medium supply device is attached or removed.

Within the scope of the invention, it is conceivable that the first hollow body and the second hollow body can be connected to each other, in particular that they form a common hollow body to which a common medium can be supplied or withdrawn instead of a first and second medium. This may be advantageous to achieve a lifting of the slatted frame and a change from the driving mode to the sleeping mode substantially in parallel or simultaneously. This may be advantageous to achieve lowering of the slatted frame and a change from sleeping mode to driving mode substantially in parallel or simultaneously. In each case, this may offer the advantage that only one common medium and/or only one medium supply device is required, and common production and/or assembly is possible, which may in particular save costs and/or weight. It can also result in particularly simple assembly and disassembly.

It is conceivable that a first pressure control element can be arranged between the first and the second hollow body, which can preferably be adjustably open, partially closed or completely closed (sealing), for example a valve or rotary valve that can be operated manually from the outside. This can be advantageous in order to initially jointly supply or withdraw a medium to the first and second hollow bodies via the first, second and/or a common connection piece, and after closing the first pressure regulating element, to supply an additional volume of the medium and/or additional pressure to the first or the second hollow body. At a greater pressure in the first hollow body, this can result in a harder support of the slatted frame, while the pressure in the second hollow body is lower, but still sufficient to bring the pop-up roof into sleeping mode or to keep it in sleeping mode. If the pressure in the first hollow body is lower, this can lead to a softer support of the slatted frame, while the pressure in the second hollow body is higher, in particular to bring the pop-up roof quickly into sleeping mode or to keep it particularly rigid in sleeping mode. Furthermore, this can be advantageous to adjust the pressure in the first or second hollow body separately and/or at a later time without affecting the pressure in the respective other hollow body.

Alternatively or in addition to the second hollow body, the drive element can have at least one mechanical drive, in particular in order to move the pop-up roof at least partially from the driving mode to the sleeping mode by raising the ceiling or in order to move the pop-up roof from the driving mode to the sleeping mode by lowering the ceiling, wherein a first end of the at least one mechanical drive can be arranged on the upwardly facing edge region of the roof and a second end can be arranged on the downwardly facing edge region of the ceiling, wherein preferably two mechanical drives are provided and a first mechanical drive is located on the right in the direction of travel and a second mechanical drive is located on the left in the direction of travel, wherein the mechanical drive can in particular have at least one lifting cylinder. In this context, it can be provided that the at least one mechanical drive can be used in addition to the second hollow body in order to support the assembly and/or disassembly of the pop-up roof, in particular in order to ensure a uniform assembly and/or disassembly. Thus, it can also be prevented that the assembly and/or disassembly is interrupted, for example because the second hollow body is blocked (e.g. by a negative pressure or positive pressure in a partial area) or has a defect, in particular by an undesired blockage. This can be advantageous, since a mechanical drive can be configured in this case in a much simpler and weight-saving manner, since the entire weight of the roof does not have to be moved by interacting with the second hollow body. It may also be provided that the at least one mechanical drive can be used for emergency operation, for example if assembly and/or disassembly of the pop-up roof by the second hollow body is not possible, in particular in the event of a defect.

According to another aspect of the present invention, it may be provided that the pop-up roof comprises at least one scissor hinge, in particular for robustly guiding the pop-up roof at least partially from the driving mode to the sleeping mode, guiding the pop-up roof at least partially from the driving mode to the sleeping mode, and/or holding the pop-up roof in the driving mode or sleeping mode. Preferably, two scissor hinges are provided, wherein a first scissor hinge is located in the driving direction on the right and a second scissor hinge is located in the driving direction on the left.

It may be provided that the at least one scissor hinge mechanically limits the expansion or build-up of the pop-up roof, for example through an external stop point, whereby during the build-up of the pop-up roof a further increase in volume of the pop-up roof is not possible when the stop point of the scissor hinge is reached. This can allow the volume of the pop-up roof to be limited.

In this context, it may be envisaged to assemble or disassemble the pop-up roof in an emergency mode purely manually, which is made possible by the guidance of the at least one scissor hinge.

The at least one scissor hinge can be reversibly detachably fastened between the upward-facing edge region of the roof and the downward-facing edge region of the ceiling. It can also be provided that the at least one scissor hinge can be assembled and disassembled without tools only for emergency operation.

According to another aspect of the present invention, it may be provided that the pop-up roof comprises at least one damper, in particular for bringing the pop-up roof in a controlled manner at least partially from the driving mode to the sleeping mode or from the driving mode to the sleeping mode. Preferably, two dampers are provided, a first damper being located on the right in the direction of travel and a second damper being located on the left in the direction of travel, the damper preferably comprising a friction damper or fluid dynamic damper.

Advantageously, the at least one damper prevents or reduces abrupt changes in position, in particular snapping, banging, and/or hard impacts during assembly or disassembly of the pop-up roof. This can increase comfort, make handling more pleasant and reduce wear.

According to a further aspect of the present invention, it may be provided that the pop-up roof comprises a third hollow body, in particular an air mattress, wherein the third hollow body is arrangeable on the slatted frame. In this case, the third hollow body is closed in a substantially medium-tight manner, and in particular the volume of the third hollow body can be reversibly reduced and increased in that a third medium, preferably air, can be introduced into the third hollow body via a third connection piece, which can be arranged on the third hollow body, in order to increase the volume through a third medium supply device, whereby, due to its expansion, this third hollow body can be at least partially, preferably completely, into the sleeping mode, in which the third hollow body is essentially at least partially, preferably completely, filled with the third medium, and can be withdrawn from the third hollow body by the third medium supply device in order to reduce the volume, in order to bring the third hollow body, by virtue of its folding, at least partially into the driving mode, in which the third hollow body essentially contains no third medium.

In the context of the present invention, a third hollow body may be understood to be a substantially elongated, ideally at least partially flexible, tube which is preferably inflatable by a third medium such as air and/or water. In other words, it may be an air mattress. Ideally, the third hollow body is substantially cuboidal in shape when in sleeping mode so that a person can comfortably spend the night lying on it. It may be envisaged not to fill the third hollow body at all and instead to use a conventional mattress or sleeping pad, preferably to accommodate different sleeping habits and needs of users.

The third hollow body can be arranged on the slatted frame in a reversibly detachable manner. Preferably, the third hollow body is thereby placed on at least one slat, in particular on the slatted frame. Thus, in other words, a bed is created in which a mattress lying on a slatted frame is provided. As a result, sleeping comfort can be greatly increased. Alternatively, it may be provided that no slatted frame is provided, and thus the third hollow body may be positioned substantially directly on the roof. In this way, a simplified and cheaper variant can be achieved, whereby in particular the elasticity or stiffness of the roof can be used to improve the sleeping comfort.

The third hollow body can be filled with a third medium, preferably a gas, in particular air, comparable to a conventional air mattress. Additionally or alternatively, the third hollow body can be filled with a liquid, preferably water, comparable to a water bed, resulting in a particularly high comfort. It may be advantageous to use warm water to provide heating in winter. It is also conceivable to use a mixture of air and water in order to achieve a temperature control via the water on the one hand and to reduce the weight compared to a complete filling with water on the other hand.

In this case, the third hollow body can be at least partially or completely filled in the driving mode. It is conceivable to adjust the hardness of the third hollow body and thus of the mattress via the degree of filling and the pressure of the third medium. In other words, it can be provided to adjust the third hollow body arbitrarily in its hardness and/or its volume, in particular to ensure an individual adjustment of the lying comfort for sleeping.

It may be envisaged that the third hollow body has a third connection piece, which is preferably closable. For example, in the simplest case it can be a preferably screwable or otherwise sealable valve, similar to a conventional air mattress, so that part of the medium cannot unexpectedly escape from the third hollow body during use (e.g. during the person sleeping in the pop-up roof). Preferably, the third connection piece, when open, may be connectable to the third medium supply device to supply or withdraw a medium from the third hollow body. The third connecting piece can have a third non-return valve, which prevents part of the medium from escaping from the third hollow body when the third medium supply device is attached or removed.

Within the scope of the invention, it is conceivable that the first hollow body and the third hollow body can be connected to each other, in particular that they form a common hollow body to which a common medium can be supplied or withdrawn instead of a first and third medium. This may be advantageous in order to achieve a lifting of the slatted frame and a filling of the third hollow body substantially in parallel or simultaneously. This may be advantageous to achieve a lowering of the slatted frame and a draining of the third hollow body substantially in parallel or simultaneously. In each case, this may offer the advantage that only one common medium and/or only one medium supply device is necessary, and common production and/or assembly is possible, which may in particular save costs and/or weight. In addition, it may be provided that only one connection nozzle has to be used for filling or draining.

It is conceivable that a second pressure control element can be arranged between the first and the third hollow body, which can preferably be adjustably open, partially closed or completely closed (sealing), for example a valve or rotary valve that can be operated manually from the outside. This can be advantageous in order to connect via the first, third and/or a common connection piece, in particular a common medium supply device, and to initially jointly supply or withdraw a medium to the first and third hollow bodies, and after closing the second pressure control element, to supply an additional volume of medium and/or additional pressure to the first or the third hollow body. If the pressure in the first hollow body is increased, this may result in a harder support of the slatted frame, while the pressure in the third hollow body is lower, but still sufficient to bring the mattress into sleeping mode or to keep it in sleeping mode. Furthermore, this can be advantageous to adjust the pressure in the first or third hollow body separately and/or at a later time without affecting the pressure in the other hollow body.

Within the scope of the invention, it is conceivable that the second hollow body and the third hollow body can be connected to each other, in particular that they form a common hollow body to which a common medium can be supplied or withdrawn instead of a second and third medium. This may be advantageous to achieve a change from driving mode to sleeping mode for the second hollow body and the third hollow body substantially in parallel or simultaneously. This may be advantageous to achieve a change from sleeping mode to driving mode for the second hollow body and the third hollow body substantially in parallel or simultaneously. In each case, this may offer the advantage that only one common medium, one connection nozzle and/or only one medium supply device is required, and common production and/or assembly is possible, which may in particular save costs and/or weight.

It is conceivable that a third pressure control element can be arranged between the second and third hollow bodies, which can preferably be adjustably open, partially closed or completely closed (sealing), for example a valve or rotary valve that can be operated manually from the outside. This can be advantageous in order to connect via the second, third and/or a common connection piece, in particular a common medium supply device, and to initially jointly supply or withdraw a medium to the second and third hollow bodies, and after closing the third pressure regulating element, to supply an additional volume of medium and/or additional pressure to the second or the third hollow body. If the pressure in the second hollow body is greater, this may result in the pop-up roof being quickly brought into sleeping mode or held particularly rigidly in sleeping mode, while the pressure in the third hollow body is less, but still sufficient to bring the third hollow body at least partially into sleeping mode or hold it in sleeping mode. Further, this may be advantageous to adjust the pressure in the second or third hollow body separately and/or at a later time without affecting the pressure in the other hollow body.

Within the scope of the invention, it is conceivable that the first, second and third hollow bodies can be connected to each other, in particular that they form a common hollow body to which a common medium can be supplied or withdrawn instead of a first, second and third medium. This may be advantageous to achieve a change from driving mode to sleeping mode substantially in parallel or simultaneously. In each case, this can offer the advantage that only one common medium, one connection piece and/or only one medium supply device is necessary, and common production and/or assembly is possible, which in particular can save costs, material and/or weight.

The first, second, and/or third pressure control element, when all are at least partially open, may allow the first, second, and third hollow bodies to be initially supplied with or deprived of a medium together. After closing at least two of the pressure control elements, the respective connected hollow bodies may each be separately supplied with or deprived of an additional volume of the medium and/or additional pressure via the first, second, and/or third connection piece. This can be advantageous in order to adjust the pressure in the first, second or third hollow body and/or at least two connected hollow bodies separately and/or at a later time without influencing the pressure in the respective other hollow body or connected hollow bodies. In addition, it is conceivable that a common medium supply device can be connected to the first, second and/or third hollow body or the common hollow body via the first, second, third and/or a common connection piece, in order to preferably enable this to supply or withdraw a first, second, third and/or common medium.

According to a further aspect of the present invention, it may be provided that the ceiling and/or the at least three walls have an outwardly facing surface which is in particular insulating, opaque, stabilizing and/or medium-tight.

It can be advantageous if the outward-facing surface has an insulating effect, for example by being at least partially mirrored, in order to reduce unwanted heat input, e.g. due to solar radiation. This can also be achieved by a separate additional sun protection layer, which can be rolled up on the outside like a roller blind and can be unrolled manually if required.

In this regard, it may be advantageous for the outward-facing surface to be opaque, particularly by having a dark plastic, to provide privacy within the pop-up roof when in sleeping mode and to ensure the safety of those inside.

It can be advantageous if the outward-facing surface has Kevlar, flow or robust plastic, for example, and is thus stabilizing in order to ensure the best possible outward shielding against mechanical stress caused by environmental influences such as water, rain, wind and solar radiation.

It can be advantageous if the surface facing outwards is medium-tight, in particular by comprising a waterproof plastic, tent fabric, rubber or neoprene, in order to prevent the penetration of external environmental influences, in particular wind, water, odors, noises and animals.

According to a further aspect of the present invention, it may be provided that the first, second and/or third medium comprises a liquid, and/or a gas, the liquid preferably comprising water, in particular with an antifreeze, the gas advantageously comprising air.

It may be provided that the first, second and third media are identical. This can be advantageous, since identical, simplified filling and emptying of the first, second and/or third hollow body can thus take place. It may be particularly preferred to use air as the first, second and third media. This offers the advantage that the first, second and/or third hollow body can each be filled or emptied by a medium supply device such as a pump or a compressor. It can also be provided that the first, second and/or third connection pieces are identically configured, whereby preferably the same adapter can be used for filling and draining.

According to a further aspect of the present invention, it may be provided that the first, second and/or third hollow body comprises at least one layer which preferably comprises a plastic such as PVC and/or TPU. Alternatively, it may be provided that the first, second and/or third hollow body comprises at least one inner layer and one outer layer, wherein the inner and outer layers are inseparably bonded to each other, in particular by vulcanization. In this case, the inner layer comprises a plastic, advantageously rubber, and the outer layer comprises a material resistant to wear, advantageously a woven sheath of polyester fibers, or a drop-stitch material.

A drop stitch material can have two layers which are connected by a plurality of polyester threads, creating a particularly resistant structure. In particular, the drop-stitch material can have an upper PVC layer. Drop stitch material can be particularly well suited to ensure both high robustness and the possibility of reversibly filling the material with a medium and emptying it again, for example with air. This results in a particularly durable and robust material that can be inflated.

According to the invention, a vehicle or a trailer, in particular a motor home or a camper van with a pop-up roof is provided.

In accordance with another aspect of the present invention, it may be provided that the pop-up roof is positionable on the roof of the vehicle or trailer, preferably with the roof of the vehicle or trailer serving at least partially as a floor for the pop-up roof. It may also be provided that the floor of the pop-up roof is located substantially directly above the roof.

According to another aspect of the present invention, it may be provided that the roof comprises an opening which connects the pop-up roof to an interior of the vehicle or trailer, and in particular allows at least one person to enter or exit the interior sleeping volume of the pop-up roof in the sleeping mode.

In other words, the opening is a hole or recess in the roof, in particular comparable to a hatch or sliding roof, which allows access to the pop-up roof, in particular in sleeping mode. This can also be openings known for camping vehicles which allow entry or exit of sleeping accommodations, in particular an alcove or roof bed. It can also be provided that the opening is only slightly smaller than the horizontal extension of the pop-up roof, whereby the pop-up roof can be accommodated at least partially, in particular the first, second and/or third hollow body, within the vehicle interior in the driving mode. This can additionally minimize the maximum overall height of the pop-up roof in the driving mode. Furthermore, components in the vehicle interior can be particularly well protected.

According to a further aspect of the present invention, it may be provided that the pop-up roof is arrangeable substantially behind a wind deflector of the vehicle or trailer, in particular to minimize air resistance. Thereby, in the driving mode, the pop-up roof can be arranged substantially completely behind the wind deflector, so that the pop-up roof is substantially not visible from the front, and ideally does not contribute to any additional air resistance, for example due to turbulence. This can be achieved in particular by minimizing the overall height of the pop-up roof. It may be provided that the pop-up roof, in particular the ceiling, is flush with the wind deflector in order to achieve an optimized streamlined fit of the vehicle. This minimizes air resistance and prevents dirt or water from accumulating between the wind deflector and the pop-up roof.

In this context, a wind deflector can essentially be understood as a spoiler that is located in the front area of the roof, preferably in front of the pop-up roof in the driving direction in the driving mode. It may be envisaged that the wind deflector is non-detachably connected to the roof, and the pop-up roof is preferably flush with the wind deflector in the driving mode. It is also conceivable that the wind deflector is connected to the roof of the pop-up roof, whereby the wind deflector in driving mode classically serves to reduce air resistance, while the wind deflector in sleeping mode serves as additional protection against external environmental influences such as rain (in the sense of a roof projection) or sunlight (in the sense of a rigid awning). In this context, it may be envisaged that the wind deflector fully surrounds the ceiling of the pop-up roof in order to realize the preceding advantages.

Furthermore, according to the invention, a method is provided for using a pop-up roof for a vehicle or a trailer, in particular for a motor home or a camper van, in particular according to any of the above embodiments, preferably according to any of claims 1 to 9. Thereby, the method may comprise the assembly and/or disassembly of a pop-up roof.

According to another aspect of the invention, there may be provided a method of assembling a pop-up roof for a vehicle or trailer, in particular for a motor home or camper van. In this regard, at least one of the following steps/stages is comprised:
Providing a pop-up roof comprising a floor, and at least three walls disposable on the floor, and a ceiling disposable on the at least three walls,
Wherein the pop-up roof is initially in a driving mode, wherein in the driving mode the ceiling and the floor are substantially contiguous to minimize the overall height of the pop-up roof
Activation of a drive device
Actuation of the drive element to bring the pop-up roof at least partially, preferably completely, reversibly from the driving mode to a sleeping mode
Wherein in the sleeping mode the ceiling, the floor and the at least three walls form an interior sleeping space volume which extends an interior space of the vehicle or trailer, in particular to provide space for a sleeping accommodation such as a bed for at least one person

In the context of the invention, activation of a drive element can mean that a first, second and/or third (or common) medium supply device, in particular a pump, is activated, for example by connecting it to a power supply. Preferably, the corresponding medium supply device may be supplied by or integrated into the on-board power supply system. It can be particularly advantageous if the first, second and/or third medium supply device is of integrated configuration, wherein this comprises a pump and/or a compressor in order to be able to supply or withdraw air, wherein preferably also a tire pressure of the vehicle or trailer can be adjusted, wherein preferably a pressure indicator and/or an overpressure valve is integrated in order to be able to prevent excessive filling and thus damage. Furthermore, an activation of a drive element may comprise the connection of a first, second and/or third medium supply device to a first, second and/or third connecting piece. For this purpose, it may be provided that the connection nozzle is opened beforehand.

In the context of the invention, actuation of the drive element can mean that filling or emptying of the first, second and/or third hollow body takes place, with the first, second and/or third connecting piece preferably being connected to the first second and/or third medium supply device. After filling or emptying, the first, second and/or third connecting piece is preferably closed again, whereby in particular the first, second and/or third hollow body is closed again in a medium-tight manner. Here, undesired emptying or filling can be prevented by a check valve provided in the connection piece.

In the context of the invention, actuation of the drive element can in particular be understood to mean that a second medium is supplied to or withdrawn from the second hollow body, in particular via a second medium supply device which is connected to the second hollow body via a second connection piece. Thereby, the pop-up roof can be built up during an enlargement of the second hollow body or a supply of the second medium into it, until the pop-up roof is substantially completely built up, and is in particular in the sleeping mode. The pop-up roof can be disassembled by reducing the size of the second hollow body or by withdrawing the second medium therefrom until the pop-up roof is substantially completely disassembled, and is in particular in the driving mode.

In this case, the pop-up roof can preferably be substantially fully built up (in sleeping mode) when the volume of the second hollow body is substantially maximized and, in particular, further supply of a medium substantially only increases the pressure inside the second hollow body but hardly increases its volume. In other words, the second hollow body may then be maximally inflated, similar to a fully (or bulging) inflated beach ball or bicycle inner tube.

In this context, the pop-up roof may preferably be substantially completely deflated (in driving mode) when the volume of the second hollow body is substantially minimized and, in particular, further withdrawal of a (second) medium is no longer possible. In other words, the second hollow body may then be completely empty, similar to a limp uninflated beach ball or a bicycle inner tube.

Due to the arrangement, in particular fastening, of the second hollow body to the roof and to the ceiling, it is thus possible to achieve, via the volume of the second hollow body, a build-up (when the volume increases) and a breakdown (when the volume decreases) of the pop-up roof, and in particular also a persistence in the driving mode or sleeping mode, if the volume remains essentially unchanged. This can also be compared to a bouncy castle that holds its shape when inflated.

Activation of the drive element can alternatively or additionally also comprise the application of force to at least one lifting cylinder. An actuation can alternatively or additionally also comprise the raising or lowering of the pop-up roof by the at least one lifting cylinder, for example by supplying or withdrawing a working fluid from it.

According to another aspect of the invention, the method may be provided for using, in particular disassembly, a pop-up roof for a vehicle or trailer, in particular for a motor home or camper van. In this regard, at least one of the following steps/stages is comprised:
Providing a pop-up roof comprising a floor, and at least three walls disposable on the floor, and a ceiling disposable on the at least three walls,
Wherein the pop-up roof is initially in a sleeping mode, wherein in the sleeping mode the ceiling, the floor and the at least three walls form an interior sleeping space volume which extends an interior space of the vehicle or trailer, in particular to provide space for a sleeping accommodation such as a bed for at least one person
Activation of a drive device
Actuation of the drive element to bring the pop-up roof at least partially, preferably completely, from a sleeping mode to a driving mode
Whereas in driving mode, the ceiling and floor are essentially adjacent to each other to minimize the overall height of the pop-up roof

Further advantages, features and details of the invention will be apparent from the following description, in which several embodiments of the invention are described in detail with reference to the drawings. In this connection, the features mentioned in the claims and in the description may each be essential to the invention individually or in any combination. Thereby show

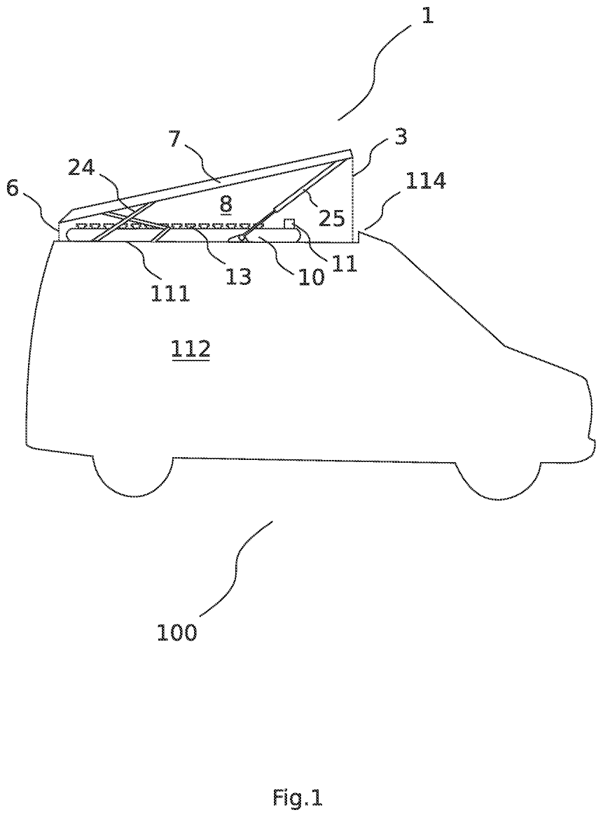

FIG. 1: A schematic representation of a pop-up roof 1 according to the invention,

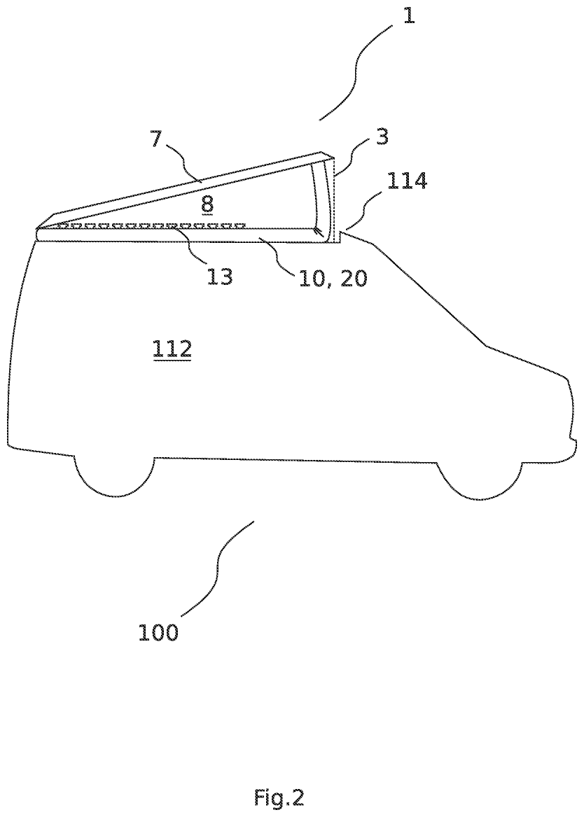

FIG. 2: A schematic representation of a pop-up roof 1 according to the invention,

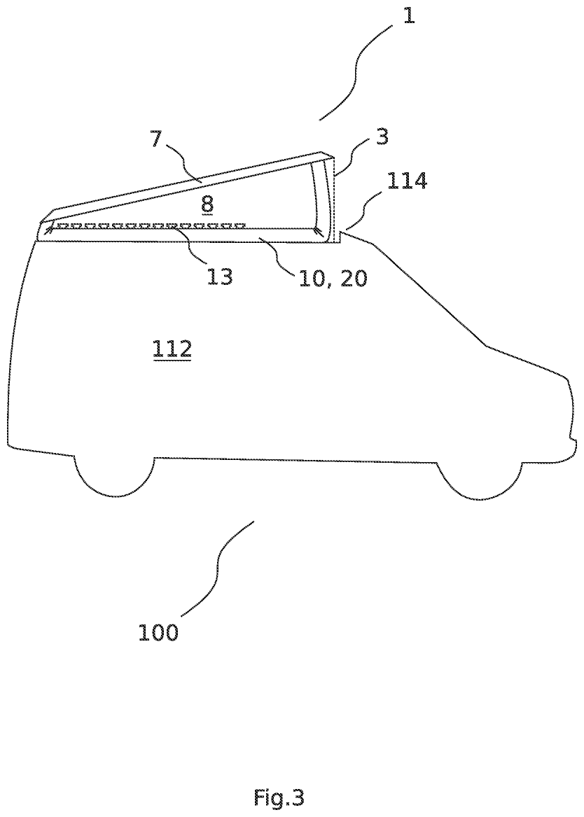

FIG. 3: A schematic representation of a pop-up roof 1 according to the invention,

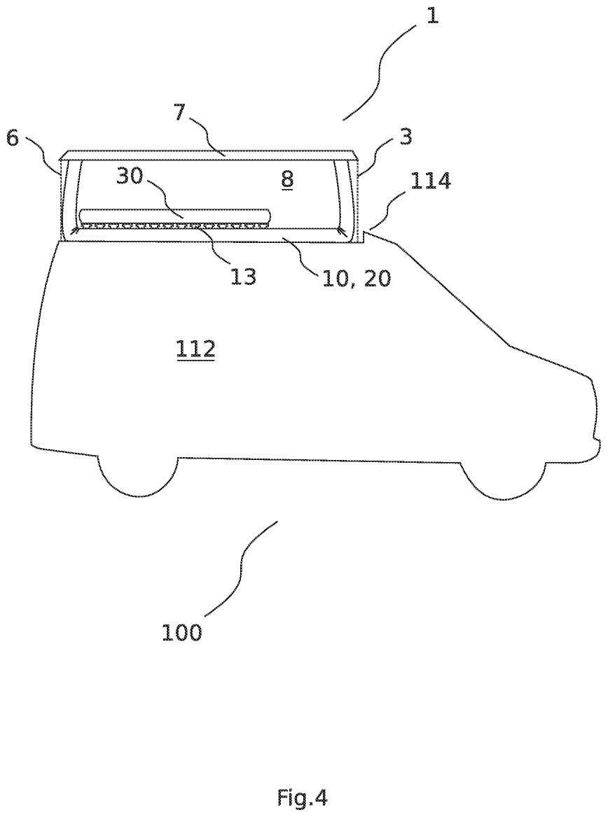

FIG. 4: A schematic representation of a pop-up roof 1 according to the invention,

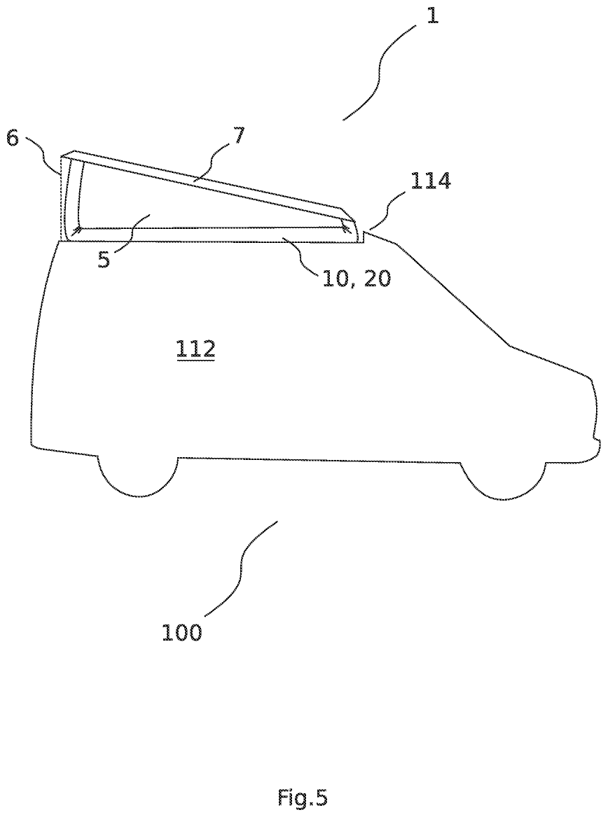

FIG. 5: A schematic representation of a pop-up roof 1 according to the invention,

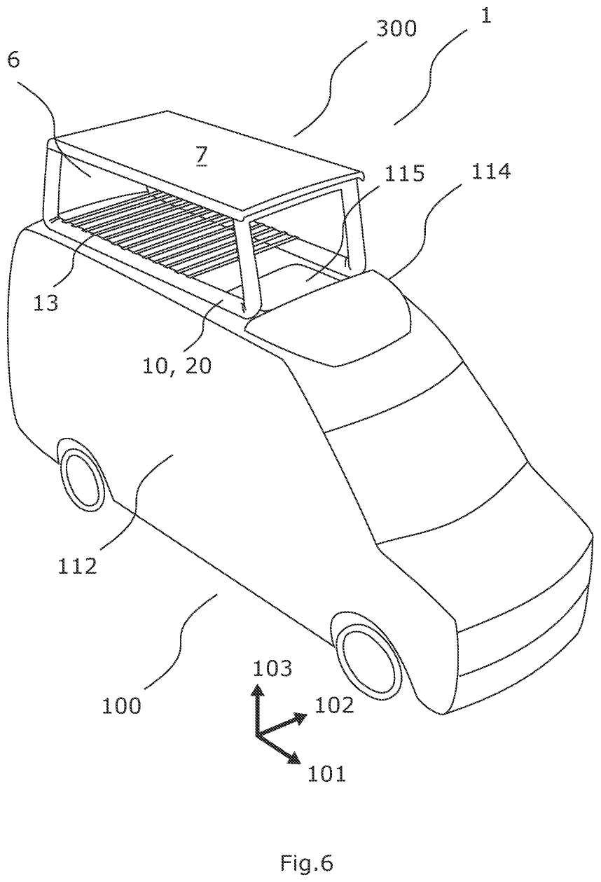

FIG. 6: A schematic representation of a pop-up roof 1 according to the invention,

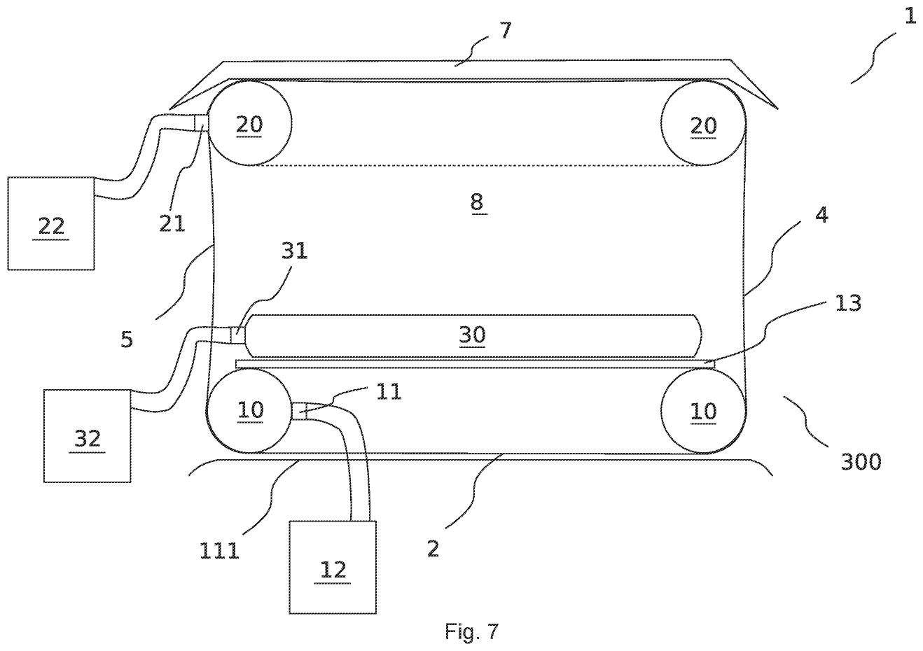

FIG. 7: A schematic representation of a pop-up roof 1 according to the invention in sleeping mode 300,

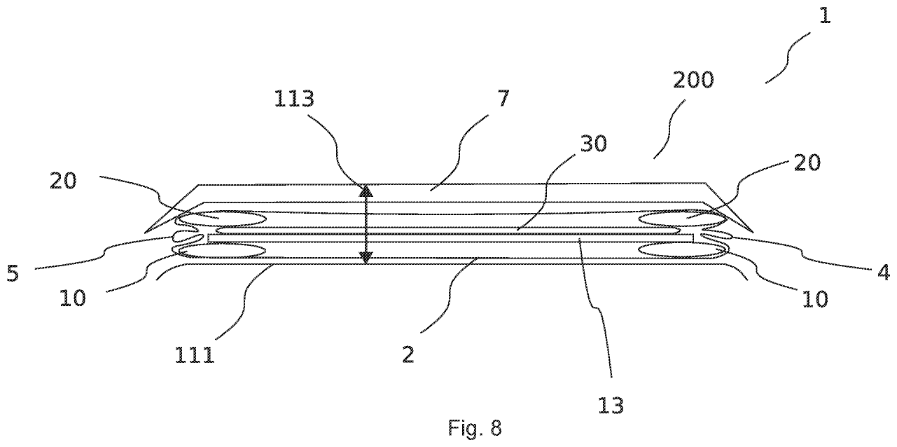

FIG. 8: A schematic representation of a pop-up roof 1 according to the invention in driving mode 200.

FIG. 1 shows a vehicle 100, in this case a motor home, with a pop-up roof 1 in sleeping mode 300, which is arranged on the roof 111 of the vehicle 100. This can be arranged substantially completely behind the wind deflector 114, in the driving mode 200, thereby minimizing air resistance. In order to move from the driving mode 200 to the sleeping mode 300, the pop-up roof 1 is in this case manually assembled by pulling it upwards, whereby due to the guidance by the at least one scissor hinge 24 the pop-up roof 1 can be brought into the sleeping mode 300. In this case, a damper 25 is also shown, which in particular prevents a hard stop, and moreover can also contribute to the guidance. The pop-up roof 1 has a ceiling 7 which, in the sleeping mode 300, together with the shown front wall 3 and the rear wall 6, and in particular with the not shown left wall 4 (in the direction of travel), the not shown right wall 5 (in the direction of travel), and in particular the not shown floor 2 located directly above the roof 111, delimits an interior sleeping space volume 8 which provides space for sleeping for at least one person, and advantageously increases the interior space 112 of the vehicle 100. Also shown is a first hollow body 10, which has a first connection piece 11, in particular for having a first medium, for example air, supplied to or withdrawn from it via a first medium supply device 12, which is not shown. At least one slat 13 is fixed to the first hollow body 10, preferably a plurality of slats is fixed thereto, so as to form a slatted frame similar to a conventional bed. In other words, it may thus be an inflatable slatted frame. In this context, the pop-up roof 1 shown in FIG. 1 may additionally or alternatively have a drive element, 23 in particular a second hollow body, in order to enable a change between the driving mode 200 and the sleeping mode 300. It is also conceivable that the drive element 23 alternatively or additionally comprises at least one lifting cylinder in order to ensure or support the assembly and disassembly of the pop-up roof 1.

FIG. 2 shows a vehicle 100 with a pop-up roof 1 in sleeping mode 300, which can be arranged behind the wind deflector 114 in driving mode 200 to minimize air resistance. Also shown is at least one slat 13 of a slatted frame on which, in particular, a person can sleep. The pop-up roof 1 has a ceiling 7 which, in the sleeping mode 300, together with the front wall 3 shown and in particular with the left wall 4 (in the direction of travel), which is not shown, the right wall (in the direction of travel), which is not shown, and in particular the floor 2, which is not shown, delimits an interior sleeping space volume 8 which provides space for at least one person to spend the night and advantageously enlarges the interior space 112 of the vehicle 100. In FIG. 2, the rear wall 6 is missing in this respect, and in side view it is in particular a substantially triangular configuration, the pop-up roof 1 being substantially pivotable at the rear end. Also shown is a first hollow body 10 and a second hollow body 20, respectively. In the present case, only a combined first and second hollow body 20, respectively, is provided. In other words, it is a single hollow body which is preferably inflatable by air. Thus, by a supply or a withdrawal of a common medium, in particular a first or a second medium, the pop-up roof 1 can be assembled or disassembled, preferably by the method according to the invention. On the first or second hollow body 10, 20 at least one slat 13 is fixed, preferably a plurality of slats is fixed thereon to form a slatted frame, whereby preferably by increasing the volume of the first or second hollow body, the at least one slat 13 is raised. In other words, this results in particular in a combination of the inflatable slatted frame and drive element 23 for setting up for the pop-up roof.

FIG. 3 shows a vehicle 100 with a pop-up roof 1 in sleeping mode 300, which can be arranged behind the wind deflector 114, in driving mode 200, in order to minimize air resistance. Also shown is at least one slat 13, preferably a plurality of slats 13 are attached there to form a slatted frame on which in particular a person can sleep. The pop-up roof 1 has a ceiling 7 which, in the sleeping mode 300, together with the front wall 3 shown and the rear wall 6 not shown, and in particular with the left wall 4 not shown (in the direction of travel), the right wall not shown (in the direction of travel), and in particular the floor 2 not shown, delimits an interior sleeping space volume 8 which provides space for at least one person to spend the night, and advantageously enlarges the interior space 112 of the vehicle 100. Compared to FIG. 2, the rear part of the pop-up roof 1 is also raised or the ceiling 7 is raised from the roof 111 of the vehicle, in particular in sleeping mode 300. Here, as in FIG. 2, there is only one common hollow body 10, 20, which can thus be described in other words as a combination of first and second hollow bodies. Through this, both the pop-up roof 1 can be brought from the driving mode 200 to the sleeping mode 300 and vice versa, preferably by the method according to the invention. In addition, the at least one slat 13 can be raised and lowered in the process.

FIG. 4 shows a vehicle 100 with a pop-up roof 1 in sleeping mode 300, which can be arranged behind the wind deflector 114 in driving mode 200 in order to minimize air resistance. Also shown is at least one slat 13, preferably a plurality of slats 13 are attached thereto to form a slatted frame on which in particular a person can sleep, wherein in particular a third hollow body 30 is provided thereon, which preferably acts as an air mattress to thereby maximize comfort. The pop-up roof 1 has a ceiling 7 which, in the sleeping mode 300, together with the front wall 3 and the rear wall 6 shown, and in particular with the left wall 4 (in the direction of travel), which is not shown, the right wall 5 (in the direction of travel), which is not shown, and in particular the floor 2, which is not shown, delimits an interior sleeping space volume 8 which provides space for at least one person to sleep overnight, and advantageously increases the interior space 112 of the vehicle 100. As shown in FIG. 3, this is a combined first and second hollow body 10, 20, respectively, whereby advantageously both the slatted frame or at least one slat and the pop-up roof 1 can be assembled or disassembled. The front and rear sections of the first and second hollow bodies 10, 20, respectively, are substantially the same in the present embodiment. This allows the ceiling 7 to be arranged substantially horizontally in the sleeping mode 300, thereby maximizing the interior sleeping space volume 8 in particular.

FIG. 5 shows a vehicle 100 with a pop-up roof 1 that can be positioned behind the wind deflector 114 in driving mode 200 to minimize air resistance. In FIG. 5, the pop-up roof 1 is essentially as shown in FIG. 3, but here it is opened in particular towards the rear. The pop-up roof 1 has a ceiling 7 which, in the sleeping mode 300, together with the front wall 3 not shown and the rear wall 6, and in particular with the left wall 4 not shown (in the direction of travel), the right wall 5 not shown (in the direction of travel), and in particular the floor 2 not shown, delimits an interior sleeping space volume 8 which provides space for sleeping for at least one person, and advantageously enlarges the interior space 112 of the vehicle 100.

FIG. 6 shows a vehicle 100 with a pop-up roof 1 in sleeping mode 300, which can be arranged behind the wind deflector 114, in driving mode 200, in order to minimize air resistance. Also shown is at least one slat 13, preferably a plurality of slats 13 are attached there to form a slatted frame on which in particular a person can sleep. The pop-up roof 1 has a ceiling 7 which, in the sleeping mode 300, together with the front wall 3 not shown and the rear wall 6, and in particular with the left wall 4 not shown (in the direction of travel), the right wall 5 not shown (in the direction of travel), and in particular the floor 2 not shown, delimits an interior sleeping space volume 8 which provides space for at least one person to sleep overnight, and advantageously enlarges the interior space 112 of the vehicle 100. Via an opening 115, the interior sleeping space volume 8 of the pop-up roof 1 can be accessed, in particular via the interior space 112 of the vehicle 100, and is connected thereto. The common hollow body, in other words the first and second hollow body 10, 20, respectively, is thereby arranged in sections along the left and right sides of the roof 111 of the vehicle 100 in order to advantageously be able to raise and lower the at least one slat 13. Furthermore, common hollow bodies, in other words the first and second hollow bodies 10, 20, respectively, have in sections a substantially upwardly facing section substantially at the front left and right and at the rear left and right, and in particular in this case are connected neither to the roof 111 nor to the ceiling 7. Thus, in each case, a free-floating section can result which defines the distance between the roof 111 or floor 2 and the ceiling 7 of the pop-up roof 1. At these points, the common or first or second hollow body can end, whereby the volume is comparatively smaller and the hollow body can be divided into two sides. This can be advantageous, for example, in order to fill or empty the left and right sides separately and differently. Alternatively or additionally, the first or second hollow body 10, 20 may have a substantially horizontal portion on the rear and/or front side (as shown) substantially below the ceiling 7, which in particular connects the left and right sides and is attached substantially near the edge on the downwardly facing side of the ceiling 7. Thus, a coherent hollow body can be realized, which advantageously can be filled or emptied via a single common or first or second connection nozzle. Also shown is a coordinate system comprising an x-axis 101, y-axis 102 and z-axis 103 representing a right-hand system. The pop-up roof 1 can be primarily assembled substantially along the z-direction upward and disassembled in the opposite direction. The direction of travel can be oriented along the x-axis 101.

FIG. 7 shows a pop-up roof 1 for a vehicle 100. FIG. 7 is essentially the same as the pop-up roof 1 shown in FIG. 8, but in this case in the driving mode 200. Also shown is at least one slat 13, which can be part of a slatted frame on which in particular a person can sleep. The at least one slat 13 is located in particular at sleeping height, in this case at the maximum slatted frame height, since no higher position (i.e. further up) can be set due to the first hollow body 10. The at least one slat 13 is arranged on a first hollow body 10, to which a first medium can be supplied or withdrawn via a first connection piece 11 by a first medium supply device 12. In other words, it is a slatted frame that can be inflated, for example, with air. Further shown is a second hollow body 20 which is arranged at least in sections below the ceiling 7, and to which a second medium can be supplied or withdrawn via a second medium supply device 22 connected to a second connection piece 21. A third hollow body 30 is arranged on the at least one slat 13, to which a third medium can be supplied or withdrawn via a third connection piece 31 by a third medium supply device 32. In other words, it is a mattress that can be inflated, for example with air, i.e. an air mattress. The pop-up roof 1 has a ceiling 7 which, in the sleeping mode 300 shown here, together with the front wall 3 not shown and the rear wall 6 not shown, and in particular with the left wall 4 (in the direction of travel), the right wall 5 (in the direction of travel), and in particular the floor 2 located directly above the roof 111, delimits an interior sleeping space volume 8 which provides space for at least one person to spend the night. The first, second and/or third medium supply device 12, 22, 32 can be located outside the pop-up roof 1, for example in the interior space 112 of the vehicle, in order preferably to be operable by or integrated into its on-board power supply system, or also outside the latter. It may also be envisaged that a common or the same first, second or third medium supply device 12, 22, 32 is used in each case for two or all three hollow bodies. It is also conceivable that the first and second hollow bodies are combined, in other words as a common hollow body. It is also conceivable that the first, second and third hollow bodies are embodied combined, and are preferably connected to each other, in other words forming a common hollow body. Thus, in each case the advantage arises that a common supply or a common withdrawal of a common or first, second or third medium, respectively, can take place. The common or first, second and/or third medium is preferably air.

FIG. 8 shows a pop-up roof 1 for a vehicle 100. FIG. 8 is essentially the pop-up roof 1 shown in FIG. 7, but in this case in the driving mode 200, and in particular folded or collapsed. This is achievable when the common, first, second and/or third hollow body is substantially completely deprived of the common, first, second and/or third medium, and thus these are arranged substantially planar and space-saving above the roof 111. The slatted frame 13 or the at least one slat 13 is located at driving height. The right wall 5 and the left wall 4 are thereby folded together and preferably arranged below the ceiling 7, wherein in particular also the first, second and third hollow bodies as well as the at least one slat 13 are arranged below the ceiling 7 and are thereby protected from external environmental influences such as rain or moisture. It may be provided that the edge of the ceiling 7 is substantially flush with the roof 111, preferably via a seal not shown, which preferably extends along the edge on the downwardly facing side of the ceiling 7 or on the upwardly facing side of the roof 111. In the driving mode 200, the overall height 113 of the pop-up roof 1 is substantially minimized, whereby preferably the distance between the uppermost end of the pop-up roof, in particular the upper end of the ceiling 7, occupies a minimum perpendicular distance from the roof 111 of the vehicle 100. As a result, the air resistance or the overall height 113 of the pop-up roof 1 and/or of the vehicle 100 can be minimized.

### LIST OF REFERENCE SIGNS

1 Pop-up roof
2 Floor
3 Front wall
4 Left wall
5 Right wall
6 Rear wall
7 Ceiling
8 Sleeping space volume
10 First hollow body
11 First connection piece
12 First medium supply device
13 Slat, slatted frame
20 Second hollow body
21 Second connection piece
22 Second medium supply device
23 Drive element
24 Scissors hinge
25 Damper
30 Third hollow body
31 Third connection piece
32 Third medium supply device
100 Vehicle
101 X-axis
102 Y-axis
103 Z-axis
111 Roof
112 Interior space
113 Construction height
114 Wind deflector
115 Opening
200 Driving mode
300 Sleeping mode

1-15. (canceled)

16. A Pop-up roof for a vehicle or trailer,
wherein
the pop-up roof has a floor and at least three walls (3, 4, 5, 6) which can be arranged on the floor, and the pop-up roof has a ceiling which can be arranged on the at least three walls,
wherein the pop-up roof can be reversibly brought by a drive element at least partially from a driving mode into a sleeping mode and vice versa from the driving mode into the sleeping mode,
wherein in the sleeping mode the ceiling, the floor and the at least three walls (3,4,5,6) form an interior sleeping space volume which extends an interior space of the vehicle or trailer,
wherein, in the driving mode, the ceiling and the floor are substantially adjacent to each other to minimize the construction height of the pop-up roof.

17. The pop-up roof for a vehicle or trailer according to claim 16,
wherein
the pop-up roof comprises a slatted frame which, in the driving mode, is positionable substantially parallel to the floor at a driving height substantially close to the floor and, in the sleeping mode, is positionable substantially parallel spaced from the floor above the floor at a sleeping height,
wherein the sleeping height is adjustable between the driving height and a maximum slatted height by a first hollow body,
and the volume of the first hollow body can be reversibly reduced and increased by introducing a first medium via a first connection piece, which can be arranged on the first hollow body,
to increase the volume, a first medium supply device can be introduced into the first hollow body, whereby the slatted frame can be lifted upwards, and
can be withdrawn from the first hollow body by the first medium supply device in order to reduce the volume, whereby the slatted frame can be lowered downwards.

18. The pop-up roof for a vehicle or trailer according to claim 16,
wherein
the drive element has a second hollow body, the second hollow body being closed in a substantially medium-tight manner, and the volume of the second hollow body can be reversibly reduced and increased by introducing a second medium.
to increase the volume, a second medium supply device can be introduced into the second hollow body and, due to its expansion, the pop-up roof can be brought at least partially into the sleeping mode, and
can be withdrawn from the second hollow body by the second medium supply device in order to reduce the volume and, on the basis of its folding, the pop-up roof can be brought at least partially into the driving mode,
wherein the second hollow body can be arranged at least in sections between the edge region of the ceiling and the roof of the vehicle or trailer.

19. The pop-up roof for a vehicle or trailer according to claim 16,
wherein
the pop-up roof has at least one scissor hinge.

20. The pop-up roof for a vehicle or trailer according to claim 16,
wherein
the pop-up roof has at least one damper.

21. The pop-up roof for a vehicle or a trailer according to claim 16,
wherein
the pop-up roof has a third hollow body,
wherein the third hollow body is closed in a substantially medium-tight manner.

22. The pop-up roof for a vehicle or a trailer according to claim 16,
wherein
at least the ceiling or the at least three walls (3, 4, 5, 6) have an outwardly facing surface.

23. The pop-up roof for a vehicle or a trailer according to claim 16,
wherein
at least the first, second or third medium comprises at least a liquid, r a gas.

24. The pop-up roof for a vehicle or a trailer according to claim 16,
wherein
at least the first, second or third hollow body has at least one layer
or
that the at least first, second or third hollow body comprises at least one inner layer and comprises an outer layer, wherein the inner and outer layers are inseparably connected to each other, wherein the inner layer comprises a plastic, advantageously rubber, and the outer layer comprises a material resistant to wear, advantageously a woven sheath of polyester fibers, or a drop stitch material.

25. The Vehicle or trailer with a pop-up roof according to claim 16,
wherein the pop-up roof is positionable on the roof of the vehicle or the trailer.

26. The Vehicle or trailer according to claim 25,
wherein
the roof has an opening which connects the pop-up roof to an interior space of the vehicle or of the trailer.

27. The Vehicle or trailer according to claim 25,
wherein
the pop-up roof can be arranged substantially behind a wind deflector of the vehicle or trailer.

28. A Method for using a pop-up roof for a vehicle or a trailer in particular according to claim 16.

29. The method of claim 28, comprising at least one of the following stages:
Providing a pop-up roof comprising a floor and at least three walls disassembled on the floor, and a ceiling disassembled on the at least three walls (3,4,5,6),
Wherein the pop-up roof is initially in a driving mode, wherein in the driving mode the ceiling and the floor are substantially adjacent to each other to minimize the overall height of the pop-up roof
Activation of a drive device
Actuation of the drive element to reversibly bring the pop-up roof at least partially from the driving mode to a sleeping mode
Wherein in the sleeping mode the ceiling, the floor and the at least three walls (3,4,5,6) form an interior sleeping space volume which extends an interior space of the vehicle or trailer.

30. The method according to claim 28, comprising at least one of the following stages:
Providing a pop-up roof comprising a floor and at least three walls disposable on the floor, and a ceiling disposable on the at least three walls (3, 4, 5, 6),
Wherein the pop-up roof is initially in a sleeping mode, wherein in the sleeping mode the ceiling, the floor and the at least three walls (3, 4, 5, 6) form an interior sleeping space volume which extends an interior space of the vehicle or trailer
Activation of a drive device
Actuation of the drive element to bring the pop-up roof at least partially from a sleeping mode to a driving mode
Wherein in the driving mode the ceiling and the floor are substantially adjacent to each other to minimize the construction height of the pop-up roof.

31. The pop-up roof for a vehicle or trailer according to claim 19,
wherein
the pop-up roof has at least one scissor hinge at least to guide the pop-up roof robustly at least partially from the driving mode into the sleeping mode, at least partially from the driving mode into the sleeping mode or to hold it in the driving mode or sleeping mode.

32. The pop-up roof for a vehicle or trailer according to claim 20,
wherein
the pop-up roof has at least one damper for bringing the pop-up roof at least partially from the driving mode to the sleeping mode or from the driving mode to the sleeping mode in a controlled manner.

33. The pop-up roof for a vehicle or a trailer according to claim 21,
wherein
the volume of the third hollow body can be reversibly reduced and increased by introducing a third medium via a third connection piece which can be arranged on the third hollow body for increasing the volume, can be introduced into the third hollow body by a third medium supply device and, due to the expansion thereof, can be brought at least partially into the sleeping mode, in which the third hollow body is substantially at least partially filled by the third medium, and
can be withdrawn from the third hollow body to reduce the volume by the third medium supply device in order to bring the third hollow body at least partially into the driving mode due to its folding together, in which the third hollow body contains essentially no third medium.

34. The Vehicle or trailer with a pop-up roof according to claim 25,
wherein the roof of the vehicle or of the trailer serves at least partially as a floor for the pop-up roof.

35. The Vehicle or trailer according to claim 26,
wherein
the opening allows at least one person to enter or exit the interior sleeping space volume of the pop-up roof in the sleeping mode.
